(19) United States
(12) Patent Application Publication
(10) Pub. No.: US 2020/0178501 A1
(43) Pub. Date: Jun. 11, 2020

(54) Conversion System for Stand and Fill Feeder

(71) Applicant: All Seasons Feeders, Ltd., San Antonio, TX (US)

(72) Inventor: William Zachary GATES, San Antonio, TX (US)

(21) Appl. No.: 16/709,368

(22) Filed: Dec. 10, 2019

Related U.S. Application Data
(60) Provisional application No. 62/777,530, filed on Dec. 10, 2018.

(51) Int. Cl. A01K 5/02

(52) U.S. Cl. CPC A01K 5/0225

(57) ABSTRACT

A system and method for a feeder. The feeder has a stand with a planar face. Below the stand is at least one leg which supports the stand. Extending upward from the face is at least one support and a spreader. A barrel is coupled to the at least one support. A hole in the bottom of the barrel allows feed to flow from the barrel to the downstream spreader. The system and method provide a feeder which can be filled without the use of a ladder.

### PRIORITY

The present invention claims priority to U.S. Provisional Application No. 62/777,530 filed Dec. 10, 2018, the entirety of which is hereby incorporated by reference.

### BACKGROUND OF THE INVENTION

### Technical Field

The present invention relates to a system and method for feeding.

### Description of Related Art

Feeders are used to feed wild and domestic game and livestock. A user often must climb high, including on unsafe ladders, to reach the opening to fill the feeders. Consequently, there is a need for a safer and more functional feeder.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a side view of a feeder in one embodiment;

FIG. 2 is a side view of a feeder in one embodiment;

FIG. 3 is a perspective view of a feeder in one embodiment;

FIG. 4 is an exploded perspective view of a feeder in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

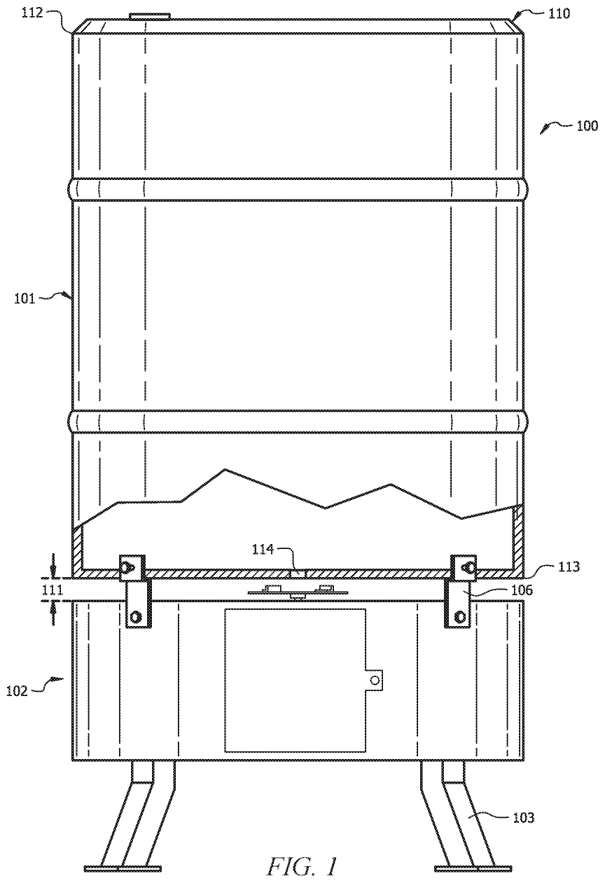

FIG. 1 is a side view of a feeder in one embodiment. The feeder 100 can comprise virtually any material. It can comprise metal, plastic, rubber, wood, and combinations thereof. The feeder 100 can be used as any feeder is currently used. It can feed domesticated and wild animals.

As shown the feeder 100 comprises two separate components which are coupled together: a barrel 101 and a stand 102. The barrel 101 can comprise any barrel known in the art. In one embodiment the barrel 101 comprises a 55 gallon barrel, or drum. Other sizes, such as 30 gallon barrels can be used as well. The barrel 101 can comprise virtually any material including rubber, plastic, metal, etc. The barrel 101 can be a new barrel, or a barrel which was used previously in a dissimilar application.

The barrel can comprise virtually any shape. In one embodiment, the barrel is cylindrical in shape. A typical barrel 101 comprises a top, a bottom, and a body. As shown, the barrel 101 comprises a lid 110. A lid 110 is an opening which allows a user to add contents to a barrel. The lid 110 can expand the entire top of the barrel 101, or just a portion of the barrel 101. While illustrated as being located on the top of the barrel, the lid 110 can be located at any place along the outer periphery of the barrel which provides access to the interior of the barrel 101.

In some embodiments the lid 110 comprises a securing device which couples and secures the lid 110 to the barrel. When the lid 110 is secured, this prevents animals from removing the lid 110 to gain entry into the barrel. The securing device can comprise a lock, a mechanical spring, or other mechanical device which secures the lid 110.

Downstream of the barrel 101 is the stand 102. As used herein downstream and upstream refer to relative locations along the feeder. Downstream refers to a location closer to the ground whereas upstream refers to a location which is further from the ground. Thus, the stand 102 is downstream of the barrel 101.

As shown the barrel 101 has a top end 112 and a bottom end 113. The bottom end 113 is downstream of the top end 113. In one embodiment the barrel has an opening or hole 114 located in the bottom end 113. This allows feed to flow downward and out from the barrel through the hole 114.

The stand 102 elevates the barrel 101 relative to the ground. The stand 102 sufficiently raises the barrel 101 to allow the feed to be spread the desired distance/pattern. The height of the stand 102 can vary depending upon the desired application. In one embodiment the stand 102 has a height which allows the user to pour feed into the top of the barrel 101 without the need for a ladder. Depending upon the height of the barrel, in one embodiment the barrel 101 and the stand 102 have a combined height of less than 7 feet. In other embodiments the barrel 101 and the stand 102 have a combined height of less than 6 feet. In still other embodiments the combined height is less than 5 feet. As noted, this allows the barrel to be filled with feed without the need for a ladder.

The stand 102 is coupled to barrel via supports 106. In one embodiment there is a distance 111 separating the bottom of the barrel 101 from the top of the stand 102. This distance 111 allows feed to be spread by the spreader 104, as discussed in more detail below. Thus, in one embodiment the barrel 101 is not adjacent to the stand 102 but is instead separated by a distance 111. The distance 111 can vary, but in one embodiment is greater than 1 inch. In one embodiment the distance 111 is greater than 2 inches.

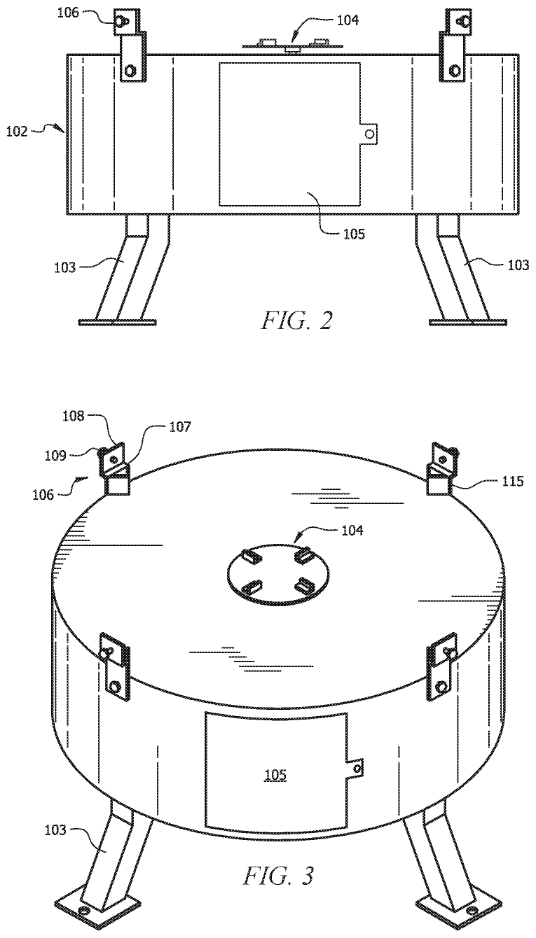

FIG. 2 is a side view of a feeder in one embodiment. In one embodiment the stand 102 houses a spreader motor. As discussed below, in some embodiments the feeder 100 comprises a spreader 104. The spreader 104 is rotated by the spreader motor, which is often housed in the stand 102.

As noted, in one embodiment, the spreader 104 is connected a shaft which is rotated by a spreader motor. As shown, and in one embodiment, the spreader 104 can be raised and lowered along the shaft relative to the stand 102. For example, in one embodiment, the spreader 104 is biased upstream, and in the upward direction by a spring. Thus, the spreader is a biased spreader. While a spring is discussed, this is for illustrative purposes only and should not be deemed limiting. Any device which can create a bias against the spreader 104 can be utilized.

Biasing the spreader 104 upwards is an advantage because it acts as a seal to close the flow of feed through the barrel 101 and the associated hole 114. In one embodiment, the spreader 104 is coupled to a weight. Thus, when the shaft begins rotating, the weight pulls the spreader 104 downstream, unsealing the feed. This allows feed to flow freely to the spreader 104 where it is spread. When not rotating, however, the spreader 104 is urged upward to close the adjacent hole 114.

As noted, in one embodiment the spreader motor is housed in the stand. As shown the stand 102 comprises one or more access ports 105 which allows the interior of the stand 102 to be accessed. Thus, in one embodiment the stand comprises an interior cavity. The interior cavity can store the motor, battery, controls, and timer. The user can open the access port 105 to adjust the time and make necessary changes to the feeder.

Downstream of the stand 102, and coupled to the stand 102, are the legs 103. The legs 103 are structures which makes contact with the ground, generally. The legs 103 are an extension of the stand 102 and provide for increased support. The legs 103 can be made integrally with the stand 102 such that the stand 102 and legs 103 comprise a single piece, or the legs 103 can comprise separate pieces which are coupled to the stand 102. The system can include virtually any number of legs 103. In one embodiment the legs 103 are coupled to the outer periphery of the stand.

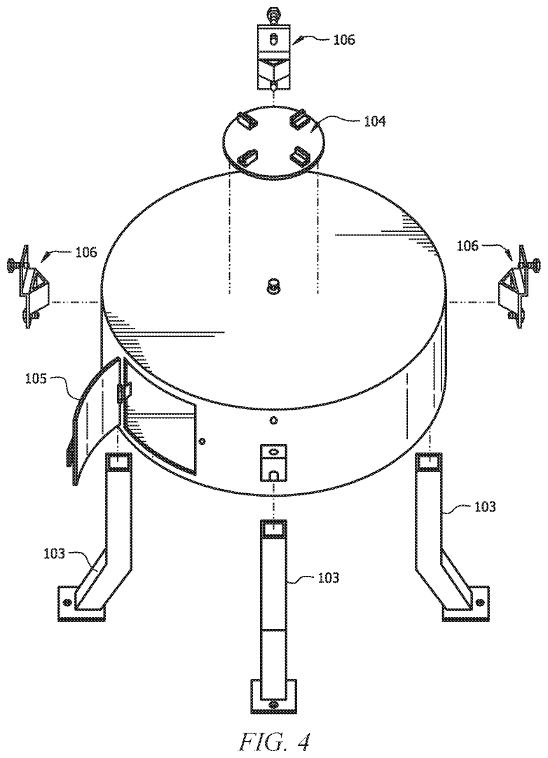

FIG. 3 is a perspective view of a feeder in one embodiment. FIG. 3 shows a better view of the supports 106 in one embodiment. As shown there are four supports 106 spread about the periphery of the stand 102. This is for illustrative purposes only and should not be deemed limiting. Also shown in FIG. 3 is that the stand 102, in one embodiment, has a circular cross-section. This allows the stand to mimic the shape of the barrel 101 to which it will couple. Thus, in one embodiment the stand 102 has a similar shape as the barrel 101.

In one embodiment the supports 106 both support the barrel 101 and couple the barrel 101 to the stand 102. In one embodiment the support comprises a Z-shape. The furthest downstream component is the vertical offset 115. The vertical offset 115 is depicted as being coupled to the stand 102. The support 106 can be coupled to the stand 102 via any method or device known in the art, including but not limited to, welding, nuts, bolts, screws, etc.

The vertical offset 115 provides the distance 111 between the bottom 113 of the barrel and the top of the stand 102. In one embodiment the vertical offset 115 is oriented to be parallel with the height of the stand 102.

The vertical offset 115 terminates with the lip 107. As shown, the lip 107 provides a surface upon which a barrel 101 can sit. In one embodiment the lip 107 is approximately perpendicular to the vertical offset 115. In one embodiment the lip 107 provides a flat, planar surface, upon which the barrel 101 can sit.

Extending from the lip 107 is the back 108. As depicted, the back 108 extends vertically from the lip 107 and is in a parallel plane as the vertical offset 115. The back 108 offers lateral support and provides a surface which allows a coupler 109 to couple to the barrel 101. A coupler 109 can comprise a screw, bolt, etc. and secures the support 106 to a barrel 101.

FIG. 4 is an exploded perspective view of a feeder in one embodiment. This figure shows the various components and how they can be assembled in one embodiment.

As noted previously, prior art feeders often required the user to engage a ladder or other device to achieve elevated heights. A safer alternative is to allow a user to stay on the ground and fill the feeder from the ground. The system and method discussed herein provides for that benefit.

As noted, the stand can be coupled to a barrel 101. Often, a barrel 101, such as a 55 gallon drum, is readily available. The system allows a standard drum to be converted into a stand and fill feeder.

First, a hole 114 in the bottom of the barrel is aligned with the below stand. In one embodiment, this hole will align with the downstream spreader 104. The size, shape, and diameter of the hole will depend upon the spreader 104. The hole 114 can either be pre-existing in the barrel 101, or the hole can be created. As an example, in one embodiment the hole 114 is drilled into the bottom end of the barrel.

Next, the barrel 101 is placed upon the stand 102. The barrel 101 is coupled to the support 106 and secured.

Thereafter, the barrel 101 is filled with feed. As previously noted, in one embodiment the stand 102 comprises a height of less than 3 feet. In one embodiment the stand has a height of less than 2 feet. Such a height allows the user to fill the feeder without need for a ladder or other structure for elevating height. Instead, the user can fill the barrel with feed while standing safely on the ground. The barrel lid 110, if so equipped, is secured. In one embodiment, due to the distance 111 and the spring in the spreader 104, the spreader 104 acts as a valve to close the hole 114 and prevent feed from spilling out undesirably.

The user will then set the time, if applicable, or provide other input as to controlling the spreader motor. As noted, when engaged the spreader 104 will spin. In one embodiment the rotation of the spreader and the associated weights, will cause the spreader to urge downstream. This will allow feed to exit through the hole 114 and onto the spreader 104. The feed will be spread through the distance 111 separating the barrel from the stand 102.

The system and method discussed herein have many advantages over the prior art. The first benefit, as discussed, is the ability to fill the feeder while standing. Rather than standing on tippy ladders, the user can stand on the firm ground and fill the feeder. Thus, the system and method discussed herein provides increased safety compared to prior art feeders.

Another benefit is the ability to convert and reuse a barrel into a feeder. Many landowners have these common barrels used for a dissimilar purpose. The system and method allow the barrels to be recycled for another purpose. Rather than throwing the barrels away, the system provides additional use for these barrels.

Another benefit is decreased cost of the feeder. Because a traditional drum is used as the hopper, the user is only purchasing a conversion kit with a stand. Thus, the user is able to obtain a stand a fill feeder for a reduced price.

While the invention has been particularly shown and described with reference to a preferred embodiment, it will be understood by those skilled in the art that various changes in form and detail may be made therein without departing from the spirit and scope of the invention.

### Additional Description

The following clauses are offered as further description of the disclosed invention.

Clause 1. A system comprising:
a stand comprising a planar face;
at least one leg coupled to said stand;
at least one support coupled to said stand;
wherein said stand comprises a spreader extending upstream from said planar face.

Clause 2. The system of any proceeding or preceding clause further comprising a barrel coupled to said stand via said support.

Clause 3. The system of any proceeding or preceding clause wherein said barrel rests upon said support to create a distance between said barrel and said stand.

Clause 4. The system of any proceeding or preceding clause wherein said barrel comprises a hole in the bottom of said barrel.

Clause 5. The system of any proceeding or preceding clause wherein said support comprises a back portion which is coupled to a lip, wherein the lip is coupled to a vertical offset, wherein said back portion and said vertical offset are approximately parallel, wherein said lip is approximately perpendicular to said vertical offset, wherein said back portion couples to said barrel, wherein said barrel rests upon said lip, and wherein said vertical offset sets the distance between the bottom of said barrel and said planar face.

Clause 6. The system of any proceeding or preceding clause wherein said stand comprises an outer perimeter, and wherein said system comprises at least four supports along said outer perimeter, and wherein said barrel has a bottom, and wherein said bottom of said barrel and said planar face are separated by a distance.

Clause 7. The system of any proceeding or preceding clause wherein said distance is greater than one inch.

Clause 8. The system of any proceeding or preceding clause wherein said stand comprises a spreader, and wherein said hole in the bottom of said barrel aligns with said spreader.

Clause 9. The system of any proceeding or preceding clause wherein said support comprises a back portion which is coupled to a lip, wherein the lip is coupled to a vertical offset, wherein said back portion and said vertical offset are approximately parallel, and wherein said lip is approximately perpendicular to said vertical offset.

Clause 10. The system of any proceeding or preceding clause wherein said stand has a height of less than 3 feet.

Clause 11. The system of any proceeding or preceding clause wherein said stand comprises a spreader.

Clause 12. The system of any proceeding or preceding clause wherein said spreader is biased.

Clause 13. The system of any proceeding or preceding clause wherein said support is Z-shaped.

Clause 14. The system of any proceeding or preceding clause wherein said stand and said barrel have a combined height of less than 6 feet.

Clause 15. A method of using converting a barrel into a feeder, said method comprising the steps of:
a) aligning a hole in the bottom of a barrel with a below stand, wherein said stand has a spreader;
b) filling said barrel with feed to be dispersed.

Clause 16. The method of any proceeding or preceding clause wherein said stand comprises a height of less than 3 feet, and wherein said filling does not require the use of a ladder.

Clause 17. The method of any proceeding or preceding clause wherein said barrel atop said stand does not exceed 6 feet in height.

Clause 18. The method of any proceeding or preceding clause further comprising the step of creating said hole in said barrel prior to said aligning of step a).

Clause 19. The method of any proceeding or preceding clause wherein said step of creating comprises using a 55 gallon drum.

What is claimed is:

1. A system comprising:
a stand comprising a planar face;
at least one leg coupled to said stand;
at least one support coupled to said stand;
wherein said stand comprises a spreader extending upstream from said planar face.

2. The system of claim 1 further comprising a barrel coupled to said stand via said support.

3. The system of claim 2 wherein said barrel rests upon said support to create a distance between said barrel and said stand.

4. The system of claim 2 wherein said barrel comprises a hole in the bottom of said barrel.

5. The system of claim 2 wherein said support comprises a back portion which is coupled to a lip, wherein the lip is coupled to a vertical offset, wherein said back portion and said vertical offset are approximately parallel, wherein said lip is approximately perpendicular to said vertical offset, wherein said back portion couples to said barrel, wherein said barrel rests upon said lip, and wherein said vertical offset sets the distance between the bottom of said barrel and said planar face.

6. The system of claim 2 wherein said stand comprises an outer perimeter, and wherein said system comprises at least four supports along said outer perimeter, and wherein said barrel has a bottom, and wherein said bottom of said barrel and said planar face are separated by a distance.

7. The system of claim 6 wherein said distance is greater than one inch.

8. The system of claim 4 wherein said stand comprises a spreader, and wherein said hole in the bottom of said barrel aligns with said spreader.

9. The system of claim 1 wherein said support comprises a back portion which is coupled to a lip, wherein the lip is coupled to a vertical offset, wherein said back portion and said vertical offset are approximately parallel, and wherein said lip is approximately perpendicular to said vertical offset.

10. The system of claim 1 wherein said stand has a height of less than 3 feet.

11. The system of claim 1 wherein said stand comprises a spreader.

12. The system of claim 1 wherein said spreader is biased.

13. The system of claim 1 wherein said support is Z-shaped.

14. The system of claim 2 wherein said stand and said barrel have a combined height of less than 6 feet.

15. A method of using converting a barrel into a feeder, said method comprising the steps of:
a) aligning a hole in the bottom of a barrel with a below stand, wherein said stand has a spreader;
b) filling said barrel with feed to be dispersed.

16. The method of claim 15 wherein said stand comprises a height of less than 3 feet, and wherein said filling does not require the use of a ladder.

17. The method of claim 15 wherein said barrel atop said stand does not exceed 6 feet in height.

18. The method of claim 15 further comprising the step of creating said hole in said barrel prior to said aligning of step a).

19. The method of claim 18 wherein said step of creating comprises using a 55 gallon drum.
